(19) United States
(12) Patent Application Publication
(10) Pub. No.: US 2003/0093785 A1
(43) Pub. Date: May 15, 2003

(54) Apparatus for storing information associated with a broadcast segment and method and system utilizing such stored information

(75) Inventor: Marc Abrahams, San Diego, CA (US)

Correspondence Address: Rogitz & Associates, 750 B Street Suite 3120, San Diego, CA, 92101, US

(73) Assignee: Sony Corporation

(21) Appl. No.: 10/000,815

(22) Filed: Nov. 14, 2001

(51) Int. Cl. H04N 7/16; H04H 9/00; H04N 7/173

(52) U.S. Cl. 725/14; 725/22; 725/15

(57) ABSTRACT

An input device for use in a system for searching a database for information associated with segments broadcast on a broadcast channel, in which the database may have a list of segments broadcast on different broadcast channels at respective times. The input device comprises a receiving circuit operable to receive channel information representing one or more broadcast channels, a channel selector operable to enable a user to select a broadcast channel from among the received channel information which corresponds to a received broadcast channel, a timer which provides time information representative of a current time, a storage device that stores at least the time information and the selected channel information, and a transmitting circuit operable to transmit the stored time information and channel information. The transmitted time information and channel information may be supplied to an external device which causes the database to be searched to select the information associated with the respective segment that was broadcast on the respective broadcast channel at a time corresponding to the time information.

### BACKGROUND OF THE INVENTION

The present invention relates to an information storage apparatus for storing broadcast segment or program information and to a system utilizing such stored information to obtain additional information corresponding thereto.

Often, when listening to a radio, a listener may hear a song that he or she likes but does not know the title thereof. As is to be appreciated, unless the radio station broadcasts the title before/after the song, it may be very difficult for the listener to obtain such title.

### SUMMARY OFTHE INVENTION

In view of the foregoing, the present invention provides an input device for use in a system for searching a database for information associated with segments broadcast on a broadcast channel, in which the database may have a list of segments broadcast on different broadcast channels at respective times. The input device comprises a receiving circuit operable to receive channel information representing one or more broadcast channels, a channel selector operable to enable a user to select a broadcast channel from among the received channel information which corresponds to a received broadcast channel, a timer which provides time information representative of a current time, a storage device that stores at least the time information and the selected channel information, and a transmitting circuit operable to transmit the stored time information and channel information. The transmitted time information and channel information may be supplied to an external device which causes the database to be searched to select the information associated with the respective segment that was broadcast on the respective broadcast channel at a time corresponding to the time information.

### BRIEF DESCRIPTION OF THE DRAWINGS

FIG. 1 is a diagram of an information storage device in accordance with an embodiment of the present invention;

FIG. 2 is a block diagram of the information storage device of FIG. 1; and

FIG. 3 is a diagram of a system to which reference will be made in explaining an operation of the information storage device of FIG. 1.

### DETAILED DESCRIPTION OF THE PREFERRED EMBODIMENTS

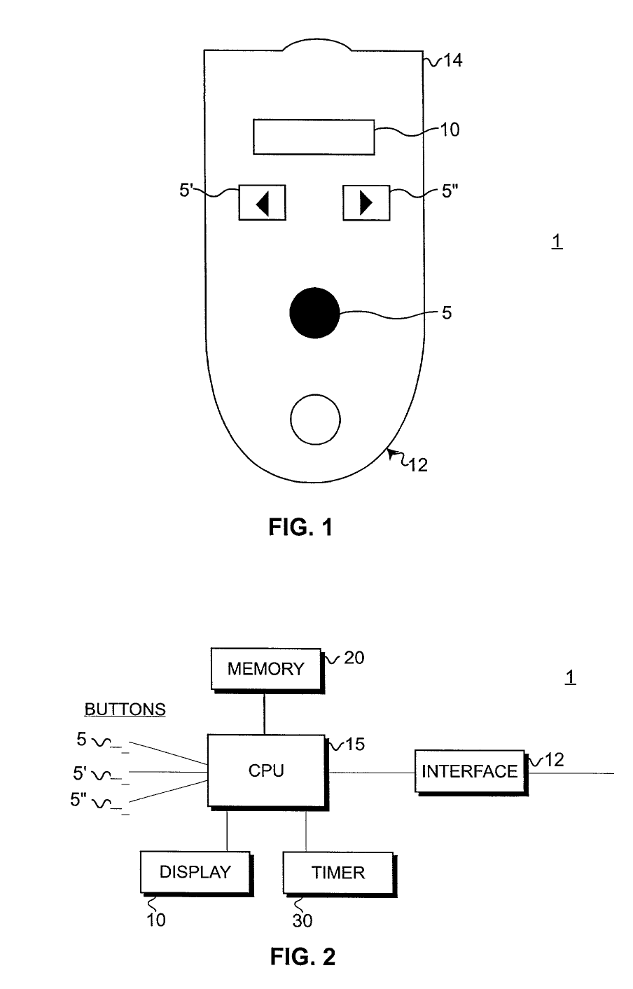

FIG. 1 illustrates an example of an input or information storage device 1 according to an embodiment of the present invention. As shown therein, information storage device 1 may include an action button 5, scroll buttons 5′ and 5″, a display unit 10, and an interface 12 accommodated in a housing 14. As shown in FIG. 2, information storage device 1 may further include a central processing unit (CPU) 15, a memory 20, and a timer 30. Advantageously, information storage device 1 may have a relatively simple construction.

Action button 5 and scroll buttons 5′, 5″ may be coupled to CPU 15 and adapted to enable a user to input information, such as information pertaining to a broadcast program, to the CPU. More particularly, scroll buttons 5′, 5″ may be adapted to enable a user to scroll through information such as a list of broadcast sources or channels or the like so as to select a desired broadcast source. For example, scroll button 5′ may enable the user to scroll through the broadcast source list in a first direction and scroll button 5″ may enable the user to scroll through the broadcast source list in a second direction which is opposite to the first direction. The action button 5 may be adapted to enable the user to cause information (such as the selected broadcast source and time) to be stored within the memory 20 of the information storage device 1.

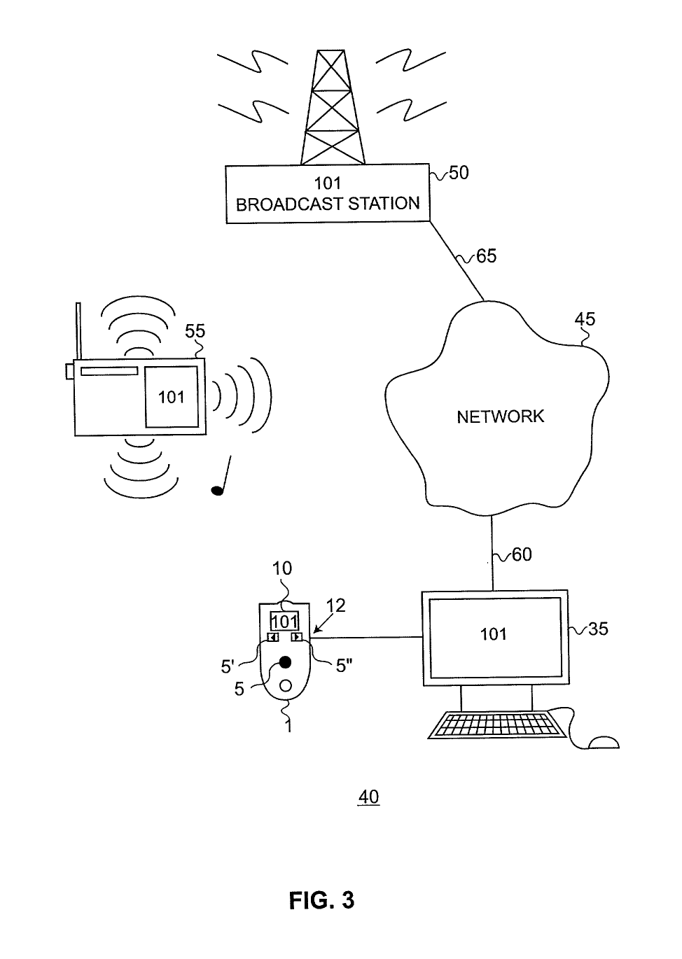

CPU 15 may be coupled to buttons 5, 5′, and 5″, display unit 10, interface 12, memory 20, and timer 30. CPU 15 may also include an internal memory, a bus, a predetermined interface, and so forth, which are not shown for the purpose of simplification. CPU 15 may be adapted to control the operations of the display unit 10, memory 20, and timer 30. Additionally, CPU 15 may be adapted to communicate with an external device, such as a computer 35 (FIG. 3), as hereinafter more fully described.

Display unit 10, which may be a liquid crystal display (LCD) or other type display, may be coupled to CPU 15 and may receive control signals therefrom. The display unit 10 is adapted to display broadcast information, such as a broadcast source, in response to a user input provided by way of the buttons 5, 5′, 5″. A default display may be included for the display unit 10 for non-preset selections. For example, a default display of “other” may be included to allow a user to store time information that is not associated with any pre-set registered selections.

Timer 30 may be coupled to CPU 15 and adapted to provide time information, such as the current time, to the CPU in response to a request. For example, when the action button 5 is activated or depressed by the user, the CPU 15 may send a request for the current time to the timer 30 and, in response thereto, the timer may send the current time to the CPU. Such time information may be stored in the memory 20. Additionally, time information may be corrected by control of CPU 15.

Memory 20, which may be a flash memory or other type of memory, may be coupled to CPU 15 and may receive control signals and information therefrom. For example, the memory may receive selected broadcast information in response to the buttons 5, 5′, 5″, time information provided by the timer 30, and a broadcast source list provided by an external source (such as the computer 35).

Interface 12 is adapted to enable communication with an external device (such as the computer 35). Interface 12 may be a wired or wireless type of interface, including the interface protocol defined in IEEE 1394 (so-called “firewire”), Universal Serial Bus (“USB”), RS-232C, infrared ray signals using an interface protocol based on Infrared Data Association (“IrDA”), and so forth.

Information storage device 1 may also be constructed as an integrated circuit (IC) card obtained by embedding an IC and a communication device in a card, or a PC card defined by Personal Computer Memory Card International Association (“PCMCIA”) and Japan Electronic Industry Development Association (“JEIDA”). In the case where information storage device 1 is constructed as an IC card, interface protocol of interface 12 may conform to the IC card construction. In the case where information storage device 1 is constructed as a PC card, a connector compatible with the PC card may be provided in computer 35 (FIG. 3).

As is to be appreciated, the external device or computer 35 would have an interface which is compatible with that of the information storage device 1. As a result, the device 1 may be coupled to the computer 35 by way of the interface 12 and the corresponding interface of the computer so as to allow data communication therebetween.

FIG. 3 illustrates a system 40 wherein the information storage device 1 may be used. As shown therein, system 40 may include information storage device 1, computer device 35, a network 45, a broadcast station 50, and a receiver device 55.

The computer device 35 may be any type of control computing device such as a general purpose computer (e.g., a personal computer or “PC”) and the like. As described above, information storage device 1 may be coupled by way of interface 12 to computer device 35. Additionally, computer device 35 may be coupled to network 45 through a network connection 60. Such network 45 may be the Internet and network connection 60 may be a modem, cable, Digital Subscriber Line (“DSL”) connection, or any type of network access connection, provided through an Internet Service Provider (“ISP”).

Broadcast station 50 may transmit signals, such as radio or television signals, which may be received by a receiving device 55 such as a radio, television, and the like. Additionally, broadcast station 50 may be linked to network 45 through a network connection 65 and may provide information pertaining to the transmitted signals thereto.

The information storage device 1 may be used to store information (such as a broadcast source and time information) pertaining to a signal received at receiving device 55 that may be used to search for additional information pertaining to the received signal by use of computer device 35. For example, consider the situation wherein a user is listening to radio 55 which is tuned to broadcast channel 101 so as to receive songs broadcast from broadcast station 50. In such situation, when the user hears a song he or she likes, the user may set broadcast channel 101 in the information storage device 1 by use of the buttons 5′, 5″ and, when it is properly set (as indicated by the display 10), the user may activate or depress button 5. As a result, information pertaining to the set broadcast channel and the current time may be supplied to the memory 20. At a later time, the stored information may be supplied from the memory 20 to the computer 35 so as to be used in obtaining information such as the title of the song.

The operations of system 40 in accordance with an exemplary embodiment of the invention will now be further described.

A user may register a number of broadcast station identifiers (which may include an identifier for broadcast station 50 such as 101 MHz) at computer device 35. In other words, the user may set or store a list of favorite radio or television stations in computer device 35, which may be identified by their frequency or call sign. Such list or information for the registered broadcast stations may be supplied to memory 20 of information storage device 1 by way of interface 12 and stored thereat. Thereafter, information storage device 1 may be uncoupled or detached from computer device 35. Such information storage device 1 (which may have a relatively small size and may have a relatively small weight) may then be carried by a user.

Receiving device 55 (which may be a radio) may be tuned to receive the broadcast signals from a broadcast station such as broadcast station 50 (101 MHz). If the user hears (or sees) a program received by receiving device 55 to his or her liking, the user may operate buttons 5′ and 5″ which controls the CPU 15 to retrieve broadcast station information from the list stored in the memory 20 and to cause the same to be displayed on the display 10. When the displayed broadcast station matches the broadcast station currently being received by receiving device 55 (such as 101 MHz), the user may then operate button 5 which is detected by CPU 15 whereupon, a program entry which may include time information (such as the current time) provided by timer 30 together with the information of the selected broadcast station (101 MHz) may be stored in memory 20.

A number of program entries each including time information and the respective broadcast station may be stored in memory 20.

Additionally, information identifying the respective information storage device 1 and/or a respective user may be stored in a predetermined area of memory 20.

The ID information, time information and selected broadcast source information associated thereto stored in memory 20 may be read out therefrom and output through interface 12 to computer device 35 on the basis of an instruction of CPU 15 or computer 35. For example, CPU 15 may include programming that enables the information to be automatically transferred whenever information storage device 1 is connected to computer device 35. In a similar manner, registered broadcast stations stored in computer device 35 may be automatically transferred to information storage device 1 upon such a connection.

Signal content information pertaining to the signal being broadcast from the respective broadcast station at the time the user pushes button 5 may be retrieved. Such signal content information may include a title, artist, publisher, and so forth, of a music piece. The broadcast signal and the corresponding content information is not limited to music pieces, but may also include other types of signals and information such as audio/video (“A/V”) pieces from a television broadcast station or Cable Television (“CATV”) station.

Signal content information may be accumulated in one or more databases. Such database(s) may be maintained at respective broadcast sources, such as broadcast station 50, or at one or more dedicated network sites (for example, web sites) on network 45, or at the computer device 35. Thus, the ID information, time information and/or the selected broadcast source information uploaded from information storage device 1 may be used to search for signal content information through network 45 using computer device 35. For example, computer device 35 may cause a search of a database to be performed to locate signal content information according to the stored time information so as to obtain information (such as the title) of a music piece broadcast from broadcast station 50 at the time the user pushed button 5. Thus, information such as the title of the music piece may be retrieved. Additionally, other information such as player (artist) information, a selling agency, a selling date, and so forth may also be retrieved.

As described above, by using system 40, a user can operate information storage device 1 to store broadcast station and time information into the information storage device, and later search for and obtain desired content information based on the stored broadcast station and time information.

Information storage device 1 is not limited to the description provided above and may be configured and/or operated differently. For example, the information storage device 1 may be installed in various other electronic devices such as a wireless telephone, a personal digital assistant (“PDA”), a so-called eMarker device and the like. An eMarker device(s) is described in U.S. patent application Ser. No. 09/401,103, filed on Sep. 22, 1999, which is incorporated herein by reference.

Further, although the information storage device 1 has been described has having two scroll buttons, one action button, a single display and so forth, the present information storage device is not so limited. For example, the present information storage device may have a different number and/or type(s) of buttons, display and so forth.

Additionally, the registered list of favorite stations may be modified.

Alternatively, the information storage device 1 may be a slave device (such as a radio, TV channel controller, or the like) controlled by a control apparatus (such as a general purpose computer). In such arrangement, a user's favorite selections or channels may be set at the control apparatus whereby the selections may be downloaded to the slave device via any type of communication, such as IEEE 1394 (so-called “firewire”), or the like. Advantageously, the user may make a selection on the slave device from a customized group that is pre-set using the control apparatus.

It will be appreciated that the present invention is applicable to analog or digital broadcasts.

Although a preferred embodiment of the present invention and modifications thereof have been described in detail herein, it is to be understood that this invention is not limited to this embodiment and modifications, and that other modifications and variations may be effected by one skilled in the art without departing from the spirit and scope of the invention as defined by the appended claims.

What is claimed is:

1. An input device for a database searching system, the system having an accumulation means for accumulating information representing broadcast segments, broadcast times at which the segments are broadcast, and broadcast sources from which the segments are broadcast, comprising:
means for selecting a broadcast source from one or more broadcast sources;
storage means for storing at least the time information representing the broadcast time at which the segment was broadcast and the broadcast source information representing the selected broadcast source; and
communication means for transmitting the time information and the broadcast source information stored in said storage means.

2. The input device as in claim 1, further comprising identification information storage means for storing identification information to uniquely identify said input device.

3. The input device as in claim 1, further comprising a connection interface for enabling said time information and broadcast source information to be transmitted from said communication means to an external computer device.

4. The input device as in claim 3, wherein said connection interface is a USB communication interface.

5. The input device as in claim 3, wherein said connection interface is an infrared ray communication interface.

6. The input device as in claim 3, wherein said connection interface is an IEEE-1394 interface.

7. The input device as in claim 3, wherein said connection interface is an RS-232C interface.

8. The input device as in claim 3, wherein when said input device and said computer device are connected by said connection interface, the time information and the broadcast source information is automatically transmitted from said input device through said connection interface to said computer device.

9. The input device as in claim 1, further comprising a portable telephone device, and wherein the input device and the portable telephone have a common housing.

10. The input device as in claim 3, wherein broadcast source information representative of a number of broadcast sources is transmitted from the computer device to the input device through said connection interface.

11. An input device for a database searching system, the system having an accumulation storage for accumulating information representing broadcast segments, broadcast times at which the segments are broadcast, and broadcast sources from which the segments are broadcast, comprising:
a selecting circuit operable to enable a user to select a broadcast source from one or more broadcast sources;
a storage device that stores at least the time information representing the broadcast time at which the segment was broadcast and the broadcast source information representing the selected broadcast source; and
a transmitting circuit coupled to the storage device that transmits the time information and the broadcast source information stored in the storage device.

12. The input device as in claim 11, further comprising an identification information storage device that stores identification information to uniquely identify said input device.

13. The input device as in claim 11, further comprising a connection interface for enabling said time information and broadcast source information to be transmitted from said transmitting circuit to an external computer device.

14. The input device as in claim 13, wherein said connection interface is a USB communication interface.

15. The input device as in claim 13, wherein said connection interface is an infrared ray communication interface.

16. The input device as in claim 13, wherein said connection interface is an IEEE-1394 interface.

17. The input device as in claim 13, wherein said connection interface is an RS-232C interface.

18. The input device as in claim 13, wherein when said input device and said computer device are connected by said connection interface, the time information and the broadcast source information is automatically transmitted from said input device through said connection interface to said computer device.

19. The input device as in claim 11, further comprising a portable telephone device, and wherein the input device and the portable telephone have a common housing.

20. The input device as in claim 13, wherein broadcast source information representative of a number of broadcast sources is transmitted from the computer device to the input device through said connection interface.

21. An input device for use in a system for searching a database for information associated with segments broadcast on a broadcast channel, said database having a list of segments broadcast on different broadcast channels at respective times, said input device comprising:
a receiving circuit operable to receive channel information representing one or more broadcast channels;
a channel selector operable to enable a user to select a broadcast channel from among the received channel information which corresponds to a received broadcast channel;
a timer which provides time information representative of a current time;
a storage device that stores at least the time information and the selected channel information; and
a transmitting circuit operable to transmit the stored time information and channel information,
whereby an external device receives the transmitted time information and channel information and causes said database to be searched to select the information associated with the respective segment that was broadcast on the respective broadcast channel at a time corresponding to said time information.

22. The input device as in claim 21, further comprising a display for displaying the selected broadcast channel.

23. The input device as in claim 21, wherein the transmitting circuit transmits identification (ID) information together with the stored time information and channel information.

24. A method of searching a database for information associated with segments of broadcast information, comprising the steps of:
accumulating a database representing said segments and broadcast times and broadcast sources of respective segments;
registering, at a computer device, one or more broadcast sources;
registering, at an input device, time information representing the broadcast time at which a user-desired segment is broadcast and broadcast source information representing a selected one of the one or more broadcast sources selected using the input device;
transmitting the registered time information and broadcast source information to a database search engine; and
using the transmitted time information and broadcast source information to search said database for information associated with those segments having broadcast times which approximately match the registered time information and broadcast sources which match the registered broadcast source information.

25. A method of searching a database for information associated with segments of broadcast information, comprising the steps of:
accumulating a database representing said segments, broadcast times at which respective segments are broadcast, and broadcast sources from which respective segments are broadcast; and
searching the database for information associated with those segments having broadcast times which match time information that is input by a user and represents the broadcast times at which respective user-desired segments are broadcast and having broadcast sources which match broadcast source information from an input device, said broadcast sources being selected using the input device from registered broadcast sources registered at a computer device.

26. A method of inputting search parameters for searching a database comprised of information representing broadcast segments, broadcast times at which segments are broadcast, and broadcast sources from which the segments are broadcast, said method comprising the steps of:
registering, at a computer device, one or more broadcast sources;
registering, at an input device, time information representing the broadcast time at which a user-desired segment is broadcast and broadcast source information representing a selected one of the one or more broadcast sources selected using the input device; and
transmitting as database search parameters the registered time information, user identification information, and the registered broadcast source information representing the selected one of the one or more broadcast sources.

27. A system for searching a database for information associated with music pieces broadcast by a broadcast station, said database storing a play list of music pieces broadcast by different broadcast stations at respective times, said system comprising:
an input terminal operable by a user to register one or more broadcast sources;
a bookmarker operable by a user to store time information representing a time at which the bookmarker is operated and broadcast source information representing a broadcast source selected from the one or more broadcast sources;
a transmitter for transmitting the stored time information and broadcast source information; and
a search engine for receiving the transmitted time, broadcast source, and ID information and for searching said database as a function of said time, broadcast source, and ID information to select information associated with a music piece that was broadcast by a broadcast source that matches said broadcast source information at a time that matches said time information.

28. The system as in claim 27, further comprising a display for displaying the selected information.

29. The system as in claim 27, wherein said transmitter transmits identification (ID) information together with the stored time information and broadcast source information.
